(19) United States
(12) Patent Application Publication
(10) Pub. No.: US 2014/0251270 A1
(43) Pub. Date: Sep. 11, 2014

(54) Throttle Body Fuel Reservoir

(71) Applicant: PC/RC PRODUCTS, L.L.C., St. Louis, MO (US)

(72) Inventors: James T. Bellistri, Wildwood, MO (US); Mazen A. Hajji, Chesterfield, MO (US); Aaron R. Wilke, Bridgeton, MO (US)

(73) Assignee: PC/RC PRODUCTS, L.L.C., Maryland Heights, MO (US)

(21) Appl. No.: 14/111,104

(22) PCT Filed: Nov. 1, 2012
(86) PCT No.: PCT/US2012/063122

§ 371 Date: Oct. 10, 2013

Related U.S. Application Data
(60) Provisional application No. 61/554,262, filed on Nov. 1, 2011.

(51) Int. Cl. F02D 41/30

(52) U.S. Cl. CPC F02D 41/30
USPC 123/399

(57) ABSTRACT

A throttle body is provided with an internal fuel reservoir for relieving pressure waves and for assisting hot start conditions of an associated small internal combustion engine employing a low pressure fuel injection system.

### CROSS-REFERENCE TO RELATED APPLICATIONS

This Non-Provisional application claims priority to U.S. Provisional Application Ser. No. 61/554,262 filed Nov. 1, 2011, and which is incorporated herein by reference.

### STATEMENT REGARDING FEDERALLY SPONSORED RESEARCH

Not Applicable.

### BACKGROUND

This invention relates generally to a fuel regulation system, and more particularly, to an electronic fuel injection system for small internal combustion engines, and to improvements in a throttle body construction for improved performance of the system.

A number of problems are encountered when adopting a low pressure electronic fuel injection system to small internal combustion engines. For instance, when attempting to restart an engine that was recently in use, sometimes referred to as a hot start, a condition known as vapor lock can stall, or prevent starting of the engine. Vapor lock occurs when the liquid fuel changes state from liquid to gas while still in the fuel delivery system. This disrupts the operation of the fuel pump, causing loss of feed pressure to the carburetor or fuel injection system, resulting in transient loss of power or complete stalling. When restarting an engine in this state, the fuel can vaporize due to being heated by the engine, by the local climate or due to a lower boiling point at high altitude. In regions where higher volatility fuels are used during the winter to improve the starting of the engine, the use of “winter” fuels during the summer can also cause vapor lock.

Another typical problem with fuel injection systems is the occurrence of pressure waves, fluctuations, or hammer effect through the system during operation. This can be caused by opening and closing of the fuel injection valve. Any of these occurrences can impair the operation of the system, cause emissions instability, and place undesirable stresses on the mechanical components of the system.

Therefore, a fuel regulation system capable of performing a hot start and avoids pressure waves, pressure fluctuations, and hammer effects during operation is needed.

### DESCRIPTION OF THE DRAWINGS

In the accompanying drawings which form part of the specification:

FIG. 1 is a perspective view of a throttle assembly for an internal combustion engine;

FIG. 2 is a second perspective view of the throttle assembly for an internal combustion engine; and

FIG. 3 is an exploded perspective view of the throttle assembly for an internal combustion engine;

FIG. 4 is a perspective view of a throttle body;

FIG. 5 is a second perspective view of the throttle body;

FIG. 6 is a side view of the throttle body; and

FIG. 7 is a block diagram of a fuel regulation system.

Corresponding reference numerals indicate corresponding parts throughout the several figures of the drawings.

### DETAILED DESCRIPTION

The following detailed description illustrates the claimed invention by way of example and not by way of limitation. The description clearly enables one skilled in the art to make and use the claimed invention, describes several embodiments, adaptations, variations, alternatives, and uses of the claimed invention, including what is presently believed to be the best mode of carrying out the claimed invention. Additionally, it is to be understood that the claimed invention is not limited in its application to the details of construction and the arrangements of components set forth in the following description or illustrated in the drawings. The claimed invention is capable of other embodiments and of being practiced or being carried out in various ways. Also, it is to be understood that the phraseology and terminology used herein is for the purpose of description and should not be regarded as limiting.

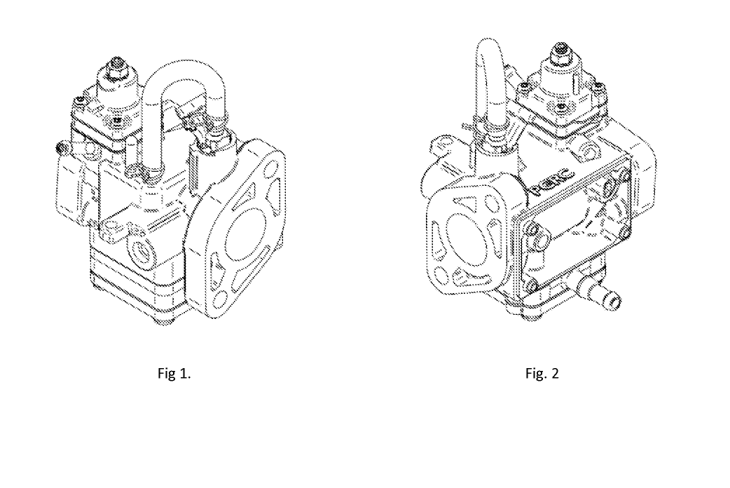

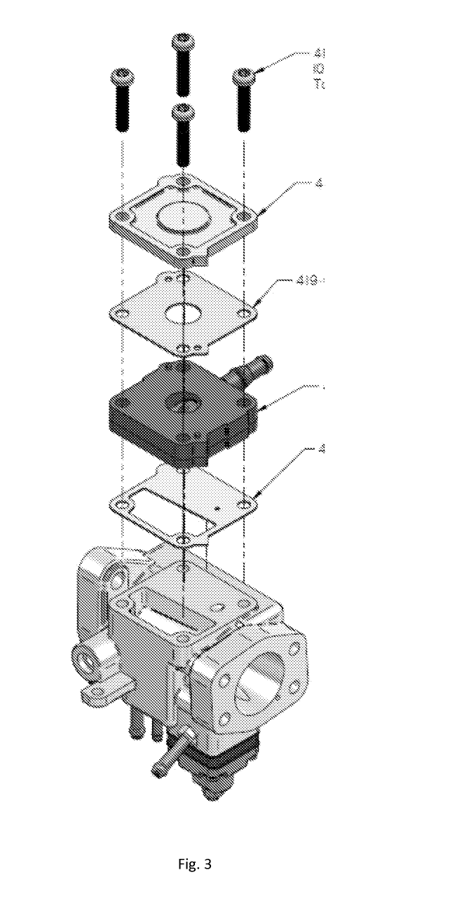

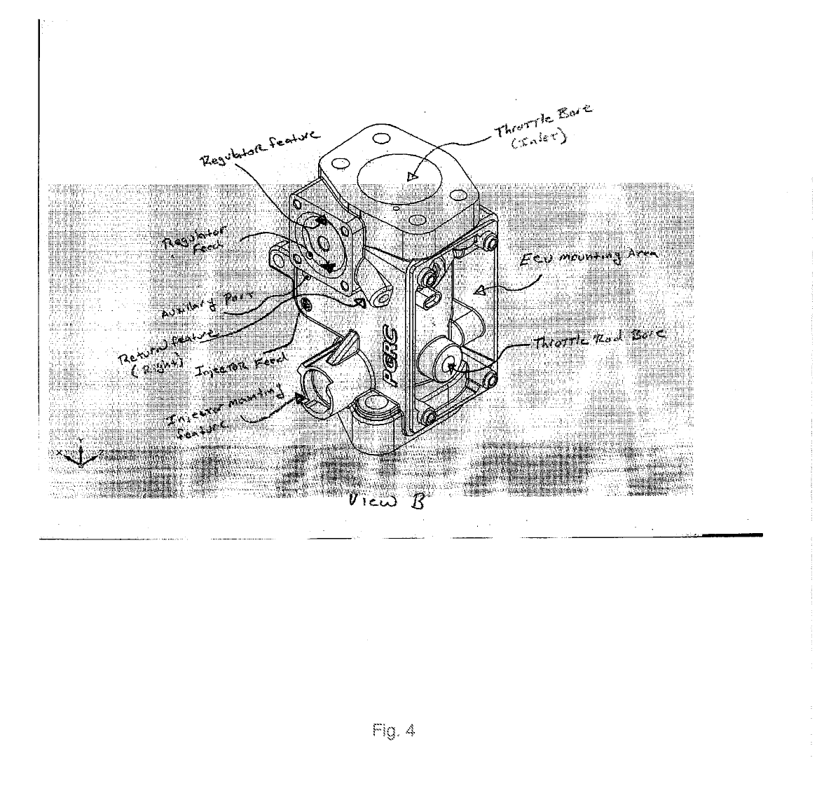

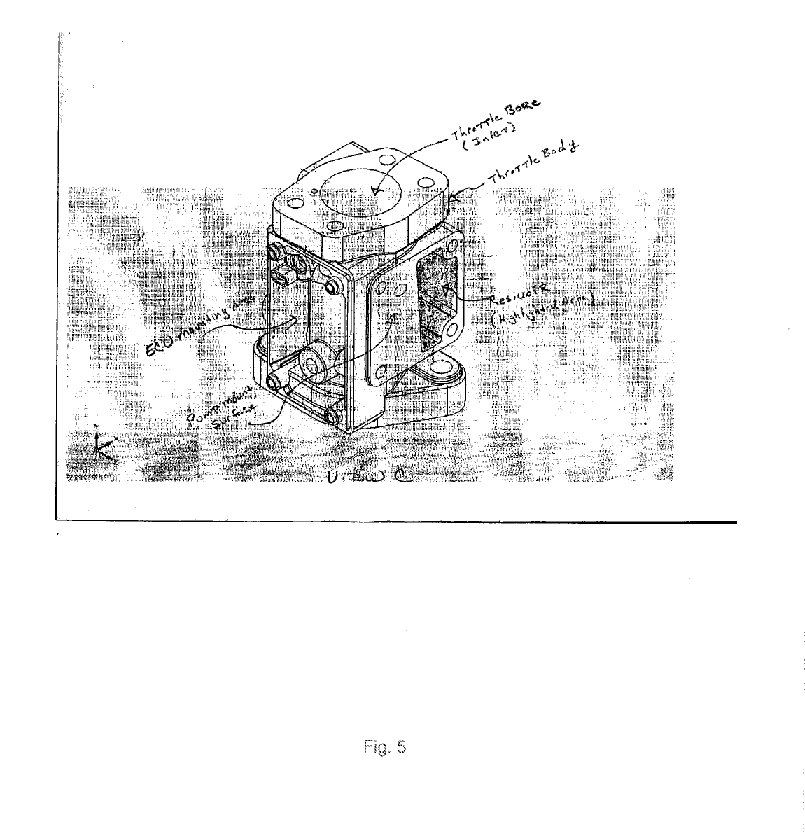

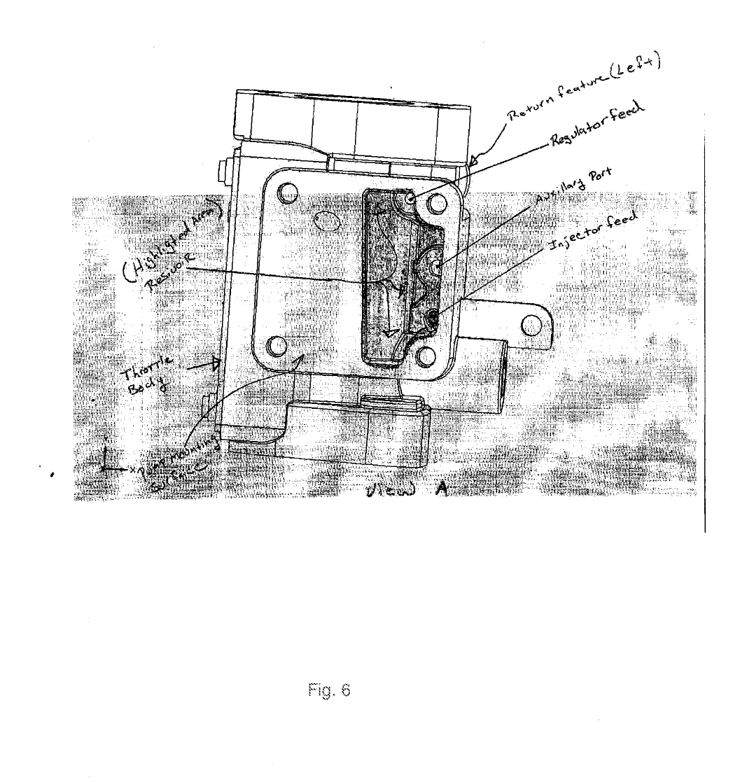

As shown in FIGS. 1-7, a, fuel regulation system 10 includes a throttle body injection assembly 12 operatively attached between a fuel supply 14 and an intake of an engine 16 for metering air and fuel to the engine 16 in a predetermined ratio controlled by an electronic control unit (ECU) 18. The throttle body injection assembly 12 includes a throttle body 15 that defines a fuel reservoir 20 configured for dampening or relief of pressure fluctuations in the system 10 and removal of vapor entrained in the fuel.

The engine 16 is preferably a four-stroke internal combustion engine, such as those used in residential and commercial power equipment, including but not limited to mowers, snow blowers, pressure washers, tractors, and generators. However, any suitable type of engine can be used.

The ECU 18 controls the operation of the system 10 using a circuit board with a microprocessor. The ECU 18 communicates with one or more sensors (not shown) positioned throughout the system 10 to receive data for determination of various elements, such as, the position of a throttle valve, the pump speed, pulse width of a fuel injector, spark ignition timing, and engine speed.

The throttle body 15 is generally rectangular prism shaped and defines a throttle bore 22 that extends from an air inlet 24 generally straight through the throttle body 15 to an outlet 26 coupled with the engine 16. Airflow through the throttle bore 22 is controlled or metered by a throttle valve 28 which is moveably attached within the throttle bore 22 and operatively connected to the ECU 18. The throttle valve 28, is preferably a butterfly valve that is pivotally attached within the throttle bore 22, however, any suitable type of valve can be used. The ECU 18 can move the throttle valve 28 variably between an open position, a closed position, and anywhere in between, to respectively increase or decrease the flow of air through the throttle bore 22 for mixing with the fuel, and flowing into the engine 16 for combustion. The throttle body 15 of FIGS. 1-7 has a lower number passages of less complexity than previously known configurations.

A fuel pump 30 mounts to a bottom surface of the throttle body 15 and operatively connects to the fuel reservoir through an opening 32 for communication of the fuel supply 14 to the fuel reservoir 20. The fuel pump 30 communicates fuel to the fuel reservoir 20 in sufficient volume to meet the engine's fuel requirement through all load conditions. The fuel pump 30 is preferably a vacuum type pump, however, any type of pump can be used. The throttle body 15 defines a relief orifice 34 configured for communicating vapor from the fuel reservoir 20 back to fuel supply 14, where the vapor can condense back into fuel.

A pressure regulator 36 mounts to the throttle body 15 and is in communication with the fuel reservoir 20 through a regulator feed channel 38 to maintain a predetermined pressure within the fuel reservoir 20 and maintain a fuel supply to a fuel injector 40 at a generally constant pressure, such as about 5-6 psi. The pressure regulator 36 is preferably a vacuum-operated diaphragm, but other types of regulators can also be used.

The fuel injector 40 mounts to an injector inlet 42 of the throttle body 15 for single point injection of the fuel into the throttle bore 22. The injector inlet 42 is positioned for injection of the fuel into the throttle bore 22 after the throttle valve 28. A fuel line 44 communicates fuel from an injector feed outlet 46 to the fuel injector 40.

When assembled, the throttle body injection assembly 12 should be positioned with the throttle bore 22 being generally vertical with the inlet 24 generally upward. The pressure regulator 36 and fuel injector 40 are positioned on a side surface of the throttle body 15, and the fuel pump 30 is positioned on an opposite side surface of the throttle body 15. In this position, the fuel reservoir 20 is positioned generally vertically so that the injector feed outlet 46 is in communication with a lower portion 50 of the fuel reservoir 20, which is generally filled with fuel, and the regulator feed channel 36 is in communication with an upper portion 52 of the fuel reservoir 20, which is generally filled with gas or vapor.

The position of the injector feed outlet 46 should be positioned at an elevation above the bottom surface of the throttle body 15 sufficient to reduce, if not eliminate, the entry of debris, water, and other undesirable materials into the injector feed outlet 46.

In operation, the fuel pump 30 communicates fuel from the fuel supply 14 to the fuel reservoir 20 of the throttle body 15 through the opening 32. A volume of fuel collects within the lower portion 50 of the fuel reservoir 20. The volume of fuel should have sufficient resident time within the fuel reservoir 20 to allow the vapors to separate from the liquid fuel and collect within the upper portion 52 of the fuel reservoir 20. The vapors are bled from the fuel reservoir 20 through the relief orifice 34 to the fuel supply 14. This reduces the amount of vapors within the fuel before the fuel enters the fuel injector 40. Thus, a generally vapor free fuel can be fed to the fuel injector 40 and allow the system to operate during a hot start. The fuel reservoir 20 also relieves pressure waves that cause water hammer type pressure spikes and contribute to engine emissions and instability.

The pressure regulator 36 exerts positive pressure on the volume of fuel to communicate fuel through the fuel line 44 and to the fuel injector 40 for injection into the throttle bore 22 for mixing with air into a predetermined ratio. The ECU 18 pivots the throttle valve 28 to allow a predetermined flow of air into the inlet 24 of the throttle bore 22 for mixing with the fuel into the predetermined ratio. The resulting air-fuel mixture flows into the engine 16 for combustion.

Changes can be made in the above constructions without departing from the scope of the invention, it is intended that all matter contained in the above description or shown in the accompanying drawings shall be interpreted as illustrative and not in a limiting sense. For example, an alternate embodiment can include a plurality of return lines installed on left, right or both sides of the throttle body depending on fuel tank location in the particular small internal combustion engine application.

1. A throttle assembly for a fuel regulation system, comprising:
a body defining a throttle bore configured for mating with an engine intake and for mounting a throttle valve;
the body defining an injector inlet configured for mounting a fuel injector in communication with the throttle bore;
the body defining a fuel reservoir with an opening being configured for receiving fuel, the fuel reservoir being configured for separating vapor from fuel;
the body defining an injector feed outlet in communication with a lower portion of the fuel reservoir, the outlet being configured for engagement with a fuel line in communication with the fuel injector; and
the body having an outer surface configured for mounting an electronic control unit in electrical communication with the throttle valve and the fuel injector for metering an air and fuel mixture to the engine intake.

2. The throttle assembly of claim 1 wherein the opening is configured to seat with a fuel pump for communicating fuel from a fuel supply.

3. The throttle assembly of claim 1 wherein the fuel reservoir is configured for dampening pressure fluctuations in the fuel regulation system.

4. The throttle assembly of claim 1 wherein the body defines a feed channel configured for mounting a pressure regulator in communication with the fuel reservoir.

5. The throttle assembly of claim 1 wherein the body defines a relief orifice configured to bleed vapor from the fuel reservoir to the fuel supply.

6. The throttle assembly of claim 1, wherein the injector feed outlet is positioned above the bottom surface of the fuel reservoir at an elevation sufficient to reduce the entry of debris materials into the outlet.

7. A fuel regulation system for an engine, comprising:
a throttle body defining a throttle bore configured for mating with an engine intake, a fuel reservoir configured for separating vapor from fuel, an opening to the fuel reservoir, an injector inlet in communication with the throttle bore;
a throttle valve mounted within the throttle bore for metering air flow into the throttle bore;
a pressure regulator configured for communication with the fuel reservoir to maintain a predetermined pressure within the fuel regulation system;
a fuel pump configured for communication of fuel from the fuel supply through the opening to the fuel reservoir;
a fuel injector mounted in the injector inlet for injection of the fuel into the throttle bore;
a fuel line configured for communication of the fuel from the fuel reservoir to the fuel injector; and
an electronic control unit in electrical communication with the throttle valve, the fuel pump, and the fuel injector for metering an air and fuel mixture to the engine intake.

8. The fuel regulation system of claim 7, wherein the fuel reservoir is configured for dampening pressure fluctuations in the fuel regulation system

9. The fuel regulation system of claim 7, wherein the throttle body defines a relief orifice configured to bleed vapor from the fuel reservoir to the fuel supply.

10. The fuel regulation system of claim 7, wherein the body defines an injector feed outlet in communication with a lower portion of the fuel reservoir, the outlet being configured for engagement with the fuel line for communication with the fuel injector.

11. The fuel regulation system of claim 10, wherein the injector feed outlet is positioned above a bottom surface of the fuel reservoir at an elevation sufficient to reduce the entry of debris materials into the injector feed outlet.

12. A method of regulating fuel to an engine, comprising the steps of:
providing a throttle body defining a throttle bore configured for mating with an engine intake, a fuel reservoir configured for separating vapor from fuel, an opening to the fuel reservoir, an injector inlet in communication with the throttle bore;
providing a throttle valve mounted within the throttle bore for metering air flow into the throttle bore;
providing a pressure regulator configured for communication with the fuel reservoir to maintain a predetermined pressure within the fuel regulation system;
providing a fuel pump configured for communication of fuel from the fuel supply through the opening to the fuel reservoir;
providing a fuel injector mounted in the injector inlet for injection of the fuel into the throttle bore;
providing a fuel line configured for communication of the fuel from the fuel reservoir to the fuel injector; and
providing an electronic control unit in electrical communication with the throttle valve, the fuel pump, and the fuel injector for metering an air and fuel mixture to the engine intake;
communicating fuel from the fuel supply to the fuel reservoir with the fuel pump;
separating vapor from the fuel into respective upper portion and lower portion of the fuel reservoir;
communicating the fuel from the lower portion of the fuel reservoir to the fuel injector;
communicating the vapor from the upper portion of the fuel reservoir to the fuel supply;
injecting fuel into the throttle bore with the fuel injector;
metering air into the throttle bore;
mixing the fuel and air into an air-fuel mixture of a predetermined ratio; and
communicating the air-fuel mixture to the engine.

13. The method of regulating fuel to an engine of claim 12, wherein the fuel reservoir is configured for dampening pressure fluctuations in the fuel regulation system

14. The method of regulating fuel to an engine of claim 12, wherein the throttle body defines a relief orifice configured to bleed vapor from the fuel reservoir to the fuel supply.

15. The method of regulating fuel to an engine of claim 12, wherein the body defines an injector feed outlet in communication with a lower portion of the fuel reservoir, the outlet being configured for engagement with the fuel line for communication with the fuel injector.

16. The method of regulating fuel to an engine of claim 15, wherein the injector feed outlet is positioned above a bottom surface of the fuel reservoir at an elevation sufficient to reduce the entry of debris materials into the injector feed outlet.

17. A fuel injection system, comprising:
a fuel tank configured to contain fuel;
an injector fluidly connected to the fuel tank by a flow path;
a pump disposed along the flow path and configured to deliver fuel to the injector; and
a vapor relief passage in fluid communication with the flow path and the fuel tank, the vapor relief passage fluidly connected to the flow path at an opening;
wherein the vapor relief passage allows vaporized fuel to return to the fuel tank from the flow path.

18. The fuel injection system of claim 17, wherein the opening is disposed in the pump.

19. The fuel injection system of claim 17, wherein the vapor relief passage bypasses the pressure regulator, thereby allowing vaporized fuel to return to the fuel tank via the vapor relief passage at pressures below the predetermined pressure.

20. The fuel injection system of claim 17, further comprising, a valve configured to selectively open and close the vapor relief passage.

21. A fuel injection system, comprising:
a fuel tank configured to contain fuel;
an injector fluidly connected to the fuel tank by a flow path;
a pump disposed along the flow path and configured to deliver fuel to the injector;
a fuel separator disposed along the flow path, the fuel separator configured to separate liquid fuel from vaporized fuel; and
a vapor relief passage in fluid communication with the fuel separator and the fuel tank, the vapor relief passage fluidly connected to the fuel separator at an opening;
wherein the vapor relief passage allows vaporized fuel to return to the fuel tank from the flow path.

22. The fuel injection system of claim 21, further comprising, a pressure regulator in fluid communication with the flow path and the fuel tank, the pressure regulator having a pressure control valve configured to allow fuel to flow from the flow path to the fuel tank if the pressure upstream of the pressure control valve exceeds a predetermined pressure.

23. The fuel injection system of claim 22, wherein the vapor relief passage bypasses the pressure regulator, thereby allowing vaporized fuel to return to the fuel tank via the vapor relief passage at pressures below the predetermined pressure.

24. The fuel injection system of claim 21, wherein the fuel separator is coupled to the throttle body.

25. A method for venting vaporized fuel from a fuel injection system, comprising:
delivering fuel from a fuel tank to an injector via a flow path;
providing a vapor relief passage with a first end in fluid communication with the fuel tank and a second end in fluid communication with the flow path; and
directing vaporized fuel from the flow path to the fuel tank through the vapor relief passage.

26. The method of claim 25, further comprising, separating vaporized fuel from liquid fuel proximate the second end of the vapor relief passage.

27. The method of claim 26, wherein the second end of the vapor relief passage is in fluid communication with the separator through an orifice.
